(19) United States
(12) Patent Application Publication
(10) Pub. No.: US 2014/0123005 A1
(43) Pub. Date: May 1, 2014

(54) USER INTERFACE FOR STREAMING MEDIA STATIONS WITH VIRTUAL PLAYBACK

(71) Applicant: Apple Inc., Cupertino, CA (US)

(72) Inventors: Scott J. Forstall, Mountain View, CA (US); Imran A. Chaudhri, San Francisco, CA (US); Lucas C. Newman, San Francisco, CA (US); Thomas Alsina, Mountain View, CA (US)

(73) Assignee: Apple Inc., Cupertino, CA (US)

(21) Appl. No.: 13/946,273

(22) Filed: Jul. 19, 2013

Related U.S. Application Data
(60) Provisional application No. 61/718,642, filed on Oct. 25, 2012.

(51) Int. Cl. G06F 3/0484; G06F 3/0481

(52) U.S. Cl. CPC G06F 3/04847; G06F 3/04817
USPC 715/716

(57) ABSTRACT

User interfaces for a streaming media system can replicate aspects of broadcast media systems. Icons representing streaming media stations region can be arranged in a scrollable array, and a visual indicator presented to identify the current station's icon. Some or all of the station icons can be “dynamic” icons that virtually play tracks by updating artwork and/or progress indicators even when a different station is current. Information about previously played tracks can be presented in a history region adjacent to a region presenting information about a current track, and an animated transition can move the current track's information to the history region when the current track finishes playing.

### CROSS-REFERENCES TO RELATED APPLICATIONS

This application is a non-provisional of U.S. Provisional Application No. 61/718,642 filed Oct. 25, 2012, the disclosure of which is incorporated by reference in its entirety.

The present disclosure is related to the following commonly-assigned co-pending U.S. Patent Applications: Provisional Application No. 61/714,717, filed on Oct. 16, 2012; Provisional Application No. 61/718,678, filed on Oct. 25, 2012, and Provisional Application No. 61/718,667, filed on Oct. 25, 2012. The respective disclosures of these applications are incorporated by reference in their entirety.

### BACKGROUND

The present disclosure relates generally to streaming media and in particular to a user interface for streaming media with virtual playback.

Increasingly, people are using electronic devices to purchase and consume digital content, including books, music, movies, and applications. One way of consuming digital content that is becoming more and more popular is “internet radio.”Internet radio generally refers to streaming music that is provided over the internet and/or other network connections to various computing devices, including desktop computers, laptop computers, and mobile devices, such as smart phones, tablet computers, and other mobile computing devices.

Some internet radio applications and services are similar to traditional radio services provided by broadcast radio stations, in that the music, advertisements, and/or other content that is broadcast and/or otherwise played is centrally controlled by a single entity, such as a disc jockey or “DJ,” for a relatively large number of listeners. In other internet radio applications and services, the advertisements, music, and/or other content that is broadcast and/or otherwise played is selected for and played to a narrower, and sometimes individual, audience.

For example, some internet radio systems may allow a user to create an internet radio station based on one or more content seeds. Like a traditional broadcast radio station, an internet radio station may represent a media channel via which a particular selection of songs and/or other content is provided, but for an internet radio station, the selection of songs that is provided may be defined based on the one or more content seeds. Typically, the content seeds are songs, albums, or artists that are selected by the user based on individual tastes and interests. An internet radio service then may select one or more songs for the created internet radio station based on the content seeds provided by the user. The selected songs then may be provided to the user, for instance, via a streaming network connection.

### SUMMARY

Certain embodiments of the present invention provide user interfaces for a streaming radio system. The interfaces can replicate various aspects of more traditional experiences such as controlling a broadcast radio (e.g, AM or FM radio), listening to a jukebox, or the like. For instance, an interface can incorporate a stations region in which stations are arranged in a array (e.g., a one-dimensional array such as a single row) of icons in a manner reminiscent of stations on a conventional broadcast radio tuner. If the number of stations defined for a particular user exceeds the available display area, the user can scroll the array to view and select additional stations. A current station indicator, which can also be reminiscent of a station indicator of a conventional broadacast radio tuner, can be used to mark the current station and can scroll together with the array. When a user selects a different station as current (also referred to as changing the station), the current station indicator can move to mark the newly selected current station.

In some embodiments, some or all of the station icons can be “dynamic” icons that can appear to be playing tracks even while the corresponding station is not selected as current. This “virtual” playback can be achieved by presenting, within each dynamic icon, artwork and/or other identifying information representative of a specific track on a playlist associated with the corresponding station. The artwork and/or other information is presented for a duration based on the duration of the specific track, after which the icon changes to display artwork and/or other information representative of the next track on the playlist associated with the corresponding station. The station icon can also include a progress indicator (e.g., a countdown timer or progress bar) that indicates the time remaining until the next track change. In these embodiments, tracks can be, in effect, played, even if content for the track is not actually being streamed or presented to the user.

In some embodiments, the interface can also provide historical information about previously played tracks. For example, the interface can include a now-playing region and a history region adjacent to the now-playing region. The now-playing region can present identifying information (e.g., artwork, title, etc.) for the track that is currently being presented to the user. The history region can present identifying information for tracks that were previously presented to the user. At the end of a track, an animated transition can be used to “move” the identifying information for the just-completed track into the history region and to “move” identifying information for the next track to be played into the now-playing region. The effect can be reminiscent of records dropping into place in an old-fashioned jukebox.

Certain aspects of the present invention relate to graphical user interfaces for a media application that provide station browsing and selection. For example, a graphical user interface can include a stations region that displays station icons. Each station icon can correspond to a different one of a number of stations defined by the media application, and each station icon can be selectable by a user to play media tracks from a playlist associated with the corresponding station. In some embodiments, some or all of the station icons can be dynamic icons that perform virtual playback. For instance, each dynamic icon can include an artwork image associated with a current media track for the corresponding station and a progress indicator that advances in emulation of real-time playback of the current media track. When the progress indicator for a particular dynamic icon reaches the end of the current media track, the image for the dynamic icon can be changed to an artwork image associated with a next media track in the playlist associated with the corresponding station, and the progress indicator can be reset, thereafter advancing again based on the duration of the next media track.

At any given time, one station can be the current station, and track content for the current station can be presented to the user (e.g., by streaming). Dynamic icons can virtually play tracks by advancing the progress indicator regardless of whether the track content is being presented to the user or not. Thus, dynamic icons can be provided for the current station and/or for stations other than the current station. When a station with a dynamic icon is selected as current, presentation of the station's playlist can begin with the track that was virtually playing when the station became current. In some embodiments, actual presentation of the track starts at the beginning; in other embodiments, the starting point for actual presentation can be determined based on the progress indicator of the virtual playback.

Each station defined in the media application can have its own station icons. The icons can be arranged in a particular order in an array (e.g., a one-dimensional array such as a row or column). If the number of station icons exceeds the available space for displaying the array, the array can be scrolled to allow different subsets of the station icons to be viewed.

A current station marker can be displayed over the station icon corresponding to the station that is currently being played (i.e., for which content is being streamed and presented to the user). When the array of station icons is scrolled, the current station marker can move with the icon for the current station. When the user selects a different station as current, an animated transition can be used to move the current station marker to the newly selected current station.

Certain aspects of the present invention relate to graphical user interfaces for a media application that provide information about a currently playing track and previously played tracks. For example, a graphical user interface can include a now-playing region that displays identifying information for a currently playing media track and a history region adjacent to the now-playing region that displays information for previously played media tracks. In some embodiments, the history region can include an arrangement of display positions, each of which presents identifying information for one of a plurality of previously played media tracks. These display positions can be arranged in an order reflecting recency of playing of the previously played tracks (e.g., left to right with most recently played on the left, or top to bottom with most recently played on top). When playing of a current media track is completed, the identifying information for the newly completed media track can moved, using an animated transition, into the first (most recently played) display position in the history region, while identifying information for each of the previously played media tracks shifts to a next display position of the history region. The animation can include resizing, rearranging, or otherwise modifying the information for the newly-completed media track.

In some embodiments, the graphical user interface can provide user-operable control elements to support user interaction with the current track and/or recently played tracks. For example, each display positions in the history region can include a control operable by a user to purchase the media track whose identifying information is displayed in that position. The now-playing region can include a purchasing control as well as other controls such as feedback controls operable to indicate the user's favorable or unfavorable opinion of the track (which can influence future track selection in the media application), a control to create a new station using the current track as a seed, and so on.

The following detailed description together with the accompanying drawings will provide a better understanding of the nature and advantages of the present invention.

### BRIEF DESCRIPTION OF THE DRAWINGS

FIG. 1 is a simplified block diagram of a system for providing a network-based radio service to a user according to an embodiment of the present invention.

FIG. 2 is a flow diagram of a process for initializing stations according to an embodiment of the present invention.

FIG. 3 illustrates a graphical user interface for a radio application according to an embodiment of the present invention.

FIGS. 4-6 illustrate a track transition for a virtually playing station in a graphical user interface according to an embodiment of the present invention. FIG. 4 illustrates the interface prior to the transition; FIG. 5 illustrates the interface during the transition; and FIG. 6 illustrates the interface after the transition.

FIGS. 7-9 illustrates scrolling of a station array and station selection in a graphical user interface according to an embodiment of the present invention. FIGS. 7 and 8 illustrate scrolling a station array, and FIG. 9 illustrates selecting a new station after scrolling.

FIG. 10 is a flow diagram of a process for managing playback for a current station according to an embodiment of the present invention.

FIG. 11 is a flow diagram of a process for managing virtual playback for a virtual station according to an embodiment of the present invention.

FIG. 12 is a flow diagram of a process for managing virtual playback for an inactive station according to an embodiment of the present invention.

FIG. 13 is a flow diagram of a process for processing a status-change event according to an embodiment of the present invention.

FIG. 14 is a timeline view illustrating transceiver usage according to some embodiments of the present invention

FIG. 15 is a flow diagram of a process for coalescing data requests according to an embodiment of the present invention.

FIGS. 16-18 illustrate a transition at the end of a playing track that can be implemented in a graphical user interface according to an embodiment of the present invention. FIG. 16 shows the interface at the end of playing a first track; FIG. 17 illustrates the interface during a transition from the first track to a second track; and FIG. 18 illustrates the interface at the end of the transition.

FIG. 19 is a flow diagram of a process for altering sound output based on touch input according to an embodiment of the present invention.

### DETAILED DESCRIPTION

Certain embodiments of the present invention provide user interfaces for a streaming radio system. The interfaces can replicate various aspects of more traditional experiences such as controlling a broadcast radio (e.g, AM or FM radio), listening to a jukebox, or the like. For instance, an interface can incorporate a stations region in which stations are arranged in a array (e.g., a one-dimensional array such as a single row) of icons in a manner reminiscent of stations on a conventional broadcast radio tuner. If the number of stations defined for a particular user exceeds the available display area, the user can scroll the array to view and select additional stations. A current station indicator, which can also be reminiscent of a station indicator of a conventional broadacast radio tuner, can be used to mark the current station and can scroll together with the array. When a user selects a different station as current (also referred to as changing the station), the current station indicator can move to mark the newly selected current staton.

In some embodiments, some or all of the station icons can be “dynamic” icons that can appear to be playing tracks even while the corresponding station is not selected as current. This “virtual” playback can be achieved by presenting, within each dymanic icon, artwork and/or other identifying information representative of a specific track on a playlist associated with the corresponding station. The artwork and/or other information is presented for a duration based on the duration of the specific track, after which the icon changes to display artwork and/or other information representative of the next track on the playlist associated with the corresponding station. The station icon can also include a progress indicator (e.g., a countdown timer or progress bar) that indicates the time remaining until the next track change. In these embodiments, tracks can be, in effect, played, even if content for the track is not actually being streamed or presented to the user.

In some embodiments, the interface can also provide historical information about previously played tracks. For example, the interface can include a now-playing region and a history region adjacent to the now-playing region. The now-playing region can present identifying information (e.g., artwork, title, etc.) for the track that is currently being presented to the user. The history region can present identifying information for tracks that were previously presented to the user. At the end of a track, an animated transition can be used to “move” the identifying information for the just-completed track into the history region and to “move” identifying information for the next track to be played into the now-playing region. The effect can be reminiscent of records dropping into place in an old-fashioned jukebox.

As used herein, the term “radio” refers generally to a streaming media service that allows a user to select from multiple coexisting playlists (or queues) of media tracks. Each playlist is associated with a “station,” and a user can select a station and thereby experience a particular playlist of media tracks. At any time the user can change to another station and experience a different playlist. The stations can be designed to play continuously without end; for example, if the end of the last track in the playlist is reached, playback can continue by replaying the first track in the playlist. In some embodiments, a station's playlist can be periodically refreshed by adding new tracks and/or removing tracks, thereby reducing repetition. In general, the playlists for different stations can include different tracks, although a given track may appear in multiple station playlists depending on how stations are defined and/or how tracks are selected for a particular station's playlist.

In embodiments described herein, media presentation can be handled using streaming technology, in which a source device can provide media content to a destination device via a network, with the destination device retaining the content in its memory long enough to present it to the user, then deleting the content. However, the present invention is not limited to streaming, and some or all of the media content being presented can be stored persistently on the presenting device.

Further, although the following description makes specific reference to presentation of audio content (e.g., songs), those skilled in the art with access to the present disclosure will recognize that similar techniques can be adapted for other types of media content (e.g., video, books, slide shows, or the like).

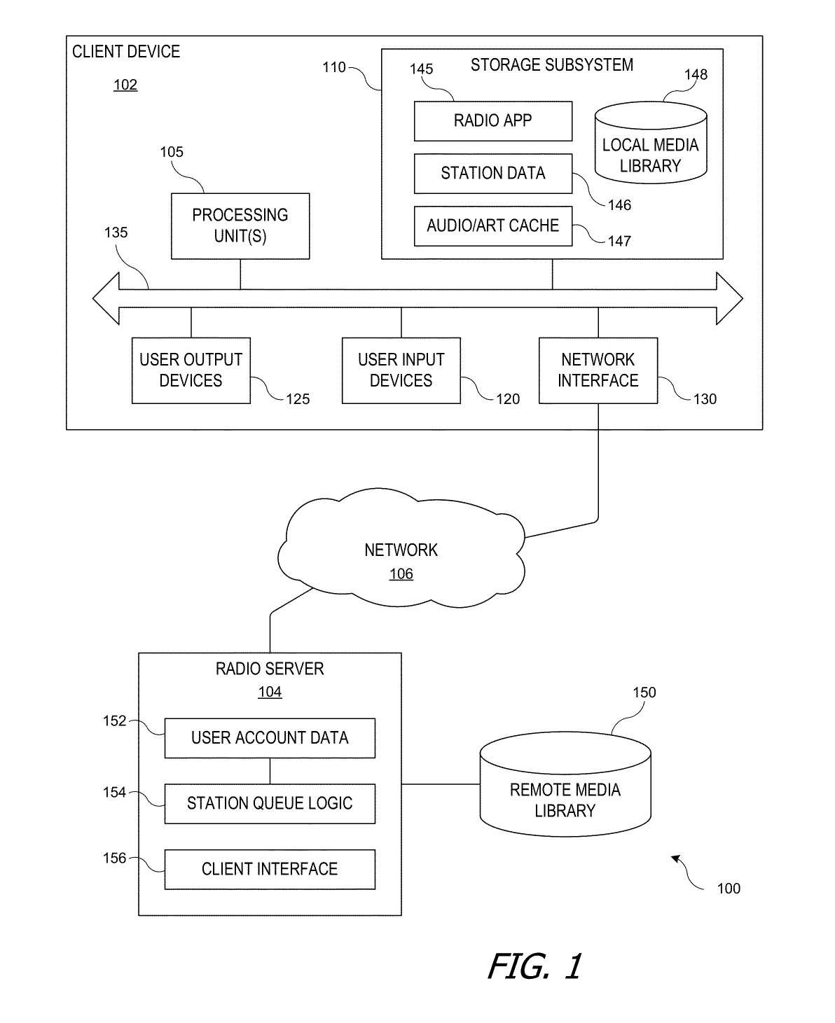

FIG. 1 is a simplified block diagram of a system 100 for providing a network-based radio service to a user according to an embodiment of the present invention. System 100 can include one or more client devices 102 that communicate with a radio server 104 via a network 106 (e.g., the Internet).

Client device 102 can be implemented as any of various computing devices or computer systems, including, e.g., a desktop or laptop computer, tablet computer, smart phone, personal data assistant (PDA), or any other type of computing device, not limited to any particular form factor. Client device 102 can include processing unit(s) 105, storage subsystem 110, input devices 120, user output devices 125, and network interface 130, all communicatively coupled to bus 135.

Processing unit(s) 105 can include a single processor, which can have one or more cores, or multiple processors. In some embodiments, processing unit(s) 105 can include a general-purpose primary processor as well as one or more special-purpose co-processors such as graphics processors, audio processors, other digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a persistent storage device. The ROM can store static data and instructions that are needed by processing unit(s) 105 and other modules of client device 102. The persistent storage device can be a read-and-write, non-volatile memory unit that stores instructions and data even when computer system 102 is powered down. Some embodiments of the invention can use a mass-storage device (such as a magnetic or optical disk or flash memory) as a persistent storage device. Other embodiments can use a removable storage device (e.g., a floppy disk, a flash drive) as a persistent storage device. The system memory can include volatile read-and-write memory devices, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blue-Ray® disks, ultra density optical disks, flash memory cards (e.g., SD cards, mini-SD cards, micro-SD cards, etc.), magnetic “floppy” disks, and so on. The computer readable storage media in subsystem 110 do not include carrier waves and transitory electronic signals passing wirelessly or over wired connections.

In some embodiments, storage subsystem 110 can store one or more software programs to be executed by processing unit(s) 105, such as a radio application 145. “Software” refers generally to sequences of instructions that, when executed by processing unit(s) 105 cause client device 102 to perform various operations, thus defining one or more specific machine implementations that execute and perform the operations of the software programs. The instructions can be stored as firmware residing in read-only memory and/or applications stored in persistent storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieve program instructions to execute and data to process in order to execute various operations described herein.

Storage subsystem 110 can also store data that is usable in connection with various stored software programs. For example, storage subsystem 110 can store data used by radio application 145, such as station data 146 for one or more internet radio stations (which can be obtained from radio server 104 as described below), and a cache 147 to temporarily store audio and/or artwork associated with the internet radio stations.

A user interface can be provided by one or more user input devices 120 and/or one or more user output devices 125. Input devices 120 can include any device via which a user can provide signals to client device 102; client device 102 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

User output devices 125 can include a display to display images generated by client device 102 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that functions as both input and output device. User output devices 125 can also include audio output devices operable to deliver sound to a user, such as speakers, speaker jacks, a headphone jack, or the like. In some embodiments, other user output devices 125 can be provided in addition to or instead of display and/or audio devices. Examples include indicator lights, speakers, tactile “display” devices, printers, and so on.

In some embodiments, user input device 120 and user output devices 125 can interoperate to provide a graphical user interface, in which visible image elements in certain areas of a display device (one of user output devices 125) are defined as active elements or control elements that the user can actuate by operating user input devices 120. For example, the user can manipulate a user input device to position an on-screen cursor or pointer over the control element, then click a button to actuate the element. Alternatively, the user can actuate a control element on a touchscreen device by touching it (e.g., with a finger or stylus). In some embodiments, the user can speak one or more words associated with the control element in order to actuate it (the word can be, e.g., a label on the element or a function associated with the element). In some embodiments, user gestures on a touch-sensitive device can be recognized and interpreted as input commands to actuate various controls; these gestures can be but need not be associated with any particular area within the display. Other user interfaces can also be implemented.

Network interface 130 can provide voice and/or data communication capability for client device 102. In some embodiments, network interface 130 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 130 can provide wired network connectivity (e.g., Ethernet) in addition to or instead of a wireless interface. Network interface 130 can be implemented using a combination of hardware (e.g., antennas, modulators/demodulators, encoders/decoders, and other analog and/or digital signal processing circuits) and software components.

Bus 135 can include various system, peripheral, and chipset buses that communicatively connect the various components of client device 102. For example, bus 135 can communicatively couple processing unit(s) 105 with storage subsystem 110. Bus 135 also connects to input devices 120 and output devices 125. Bus 135 also couples client device 102 to a network through network interface 130. In this manner, client device 102 can participate in a network 106 that can interconnect multiple computer systems (e.g., a local area network (LAN), a wide area network (WAN), an Intranet, or a network of networks, such as the Internet. Any or all components of client device 102 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionality for client device 102. For example, processing unit(s) 105 can execute radio application 145. Radio application 145 can provide various functionality such as the ability to retrieve playlists of tracks associated with different stations from radio server 104; to present tracks from a selected station to the user (e.g., by retrieving track data from a local media library 148 or from a remote media library 150 and converting the track data to analog audio output); and to receive and process user input associated with controlling operation of radio application 145, such as station creation, station selection, purchasing tracks, etc. Examples of user interfaces for radio application 145 are described below.

Radio server 104 can be a computer system incorporating similar components to client device 102 (e.g., processors, storage subsystems, input/output devices, network interfaces) and can have various form-factors. For example, radio server 104 can be implemented using scalable server technologies (e.g., blade servers and/or server farms) to manage large numbers of users and/or large volumes of data. Radio server 104 can include storage for user account data 152, software implementing station queue logic 154, and a client interface 156. In some embodiments, radio server 104 has access to a remote media library 150 (“remote” in the sense that it is remote from client device 102), either directly (as shown) or via network 106. Remote media library 150 can be a large library containing thousands or millions of tracks that can potentially be streamed to client device 102. Remote library 150 can include track content (e.g., digital audio) as well as metadata describing each track (e.g., title, artist, album, year, genre, subgenre, tempo, featured instruments, audio characteristics, mood, popularity) and associated “artwork” (typically one or more image files, which can be, e.g., images of album covers or the like) for some or all of the tracks.

In operation, radio server 104 can provide a cloud-based streaming radio service for a user. For example, radio server 104 can maintain user account data 152 for a number of user accounts. The user account data for a given user can include user-identification credentials (e.g., a username and password), as well as definitions for one or more stations associated with the user.

Stations can be defined in various ways. In some instances, a user can identify a seed song, and the station can be defined by the seed song and/or some combination of characteristics of the seed song (e.g., artist, genre, year of release, tempo, featured instruments, audio characteristics, mood, etc.). In other instances, a user can define a station based on desired characteristics (e.g., a genre such as Electronica, a sub-genre such as Chill, a particular artist, a date range such as “80's music,” a mood such as happy, etc.). In addition, some embodiments allow a user to further customize a station after it has initially been defined. For instance, as described below, while listening to a particular station, the user can indicate liking or disliking a particular track, and the user's likes and dislikes can influence future track selections for that station or across multiple stations.

In some instances, a provider of radio service 104 can also define various “featured” stations, e.g., stations associated with particular musical genres, lifestyles, or the like. In some instances, a featured station can be sponsored by a third party. Featured stations can be associated with a particular user based on user selection from a menu of featured stations, or they can be associated based on decisions made by radio server 104, e.g., based on the user's previous listening and/or media purchasing behavior. In some embodiments, multiple users can be associated with the same featured station, and each user receives the same playlist for that station on any given day.

Station queue logic 154 can be configured to generate a playlist, or queue, for each radio station associated with a given user. For example, if a station is defined with reference to a seed song (or characteristics thereof), station queue logic 154 can be configured to identify other songs in remote media library 150 with characteristics similar to the seed song and create a playlist from the identified songs; the playlist may or may not include the seed song. In the case of a featured station, station queue logic 154 may simply read a preprogrammed playlist that can be defined by an operator of radio server 104 and/or by a third-party sponsor of the station. The playlist for a given station generally includes some number of “tracks,” where the term track can include any discrete block of recorded media content such as a song, a lecture, a segment of a recorded performance, an advertisement, etc.

Client interface 156 can manage communications with one or more user computers 102. For example, client interface 156 can receive user credentials for a particular user from client device 102 via network 104, validate the credentials, and provide station information from user account data 152 to client device 102. Client interface 156 can also invoke station queue logic 154 to generate playlists for one or more stations for a particular user and can communicate the playlists to client device 102. In addition, client interface 156 can provide track content and metadata from remote media library 150 to client device 102 on request. In some embodiments, access to track content and metadata can be limited to client devices 102 that have established a session with radio server 104 using valid user credentials.

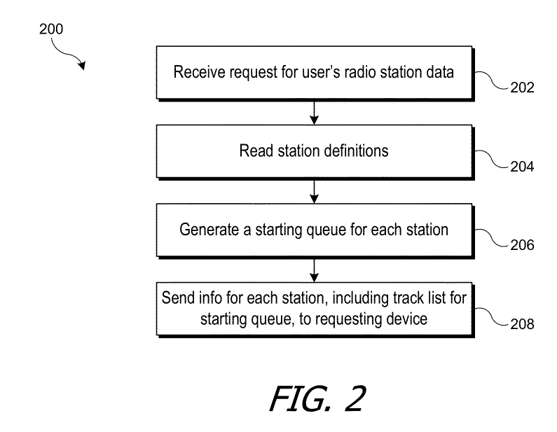

In some embodiments, when a client device 102 establishes a session for a particular user account with radio server 104, radio server 104 proceeds to initialize all of the stations defined for that user account. FIG. 2 is a flow diagram of a process 200 for initializing stations according to an embodiment of the present invention. Process 200 can be executed, e.g., by radio server 104 of FIG. 1.

At block 202, radio server 104 can receive a request for a user's station data. For instance, client device 102 can provide the user's credentials and indicate that the user has launched radio application 145. At block 204, radio server 104 can read the station definitions for the user (e.g., from user account data 152).

At block 206, radio server 104 can generate a starting playlist for each station defined for the user, e.g., by invoking station queue logic 154. In general, the length of a station's playlist can be established in any manner desired and can be varied over time, e.g., by dynamically adding and/or removing tracks. For example, to avoid repetition, it may be desirable to define a long playlist (e.g., 24 hours' worth of tracks). However, in practice a given user may have dozens or hundreds of stations defined, and generating a 24-hour playlist for every station is likely not to be necessary. Accordingly, the starting playlist can be relatively short, e.g., 10 tracks, 12 tracks, 15 tracks, or the like. (In some embodiments, the starting playlist for a station does not include advertisements.) At block 208, radio server 104 can provide station information, including the starting playlist generated for each station, to client device 102. Other information, such as station names or station identifiers (e.g., the title and/or artist for the station's seed song) can also be provided. With this information, client device 102 can initialize a user interface of radio application 145 to provide station information to a user. Examples of user interfaces for radio application 145 are described below. It will become apparent that the user interfaces described herein can be used independently of the details of generating the station playlists; accordingly, further description of generating station playlists is omitted.

It will be appreciated that network-based radio system 100 is illustrative and that variations and modifications are possible. Client device 102 can have other capabilities not specifically described here (e.g., mobile phone, global positioning system (GPS), power management, one or more cameras, various connection ports for connecting external devices or accessories, etc.). Further, while the components of system 100 have been described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

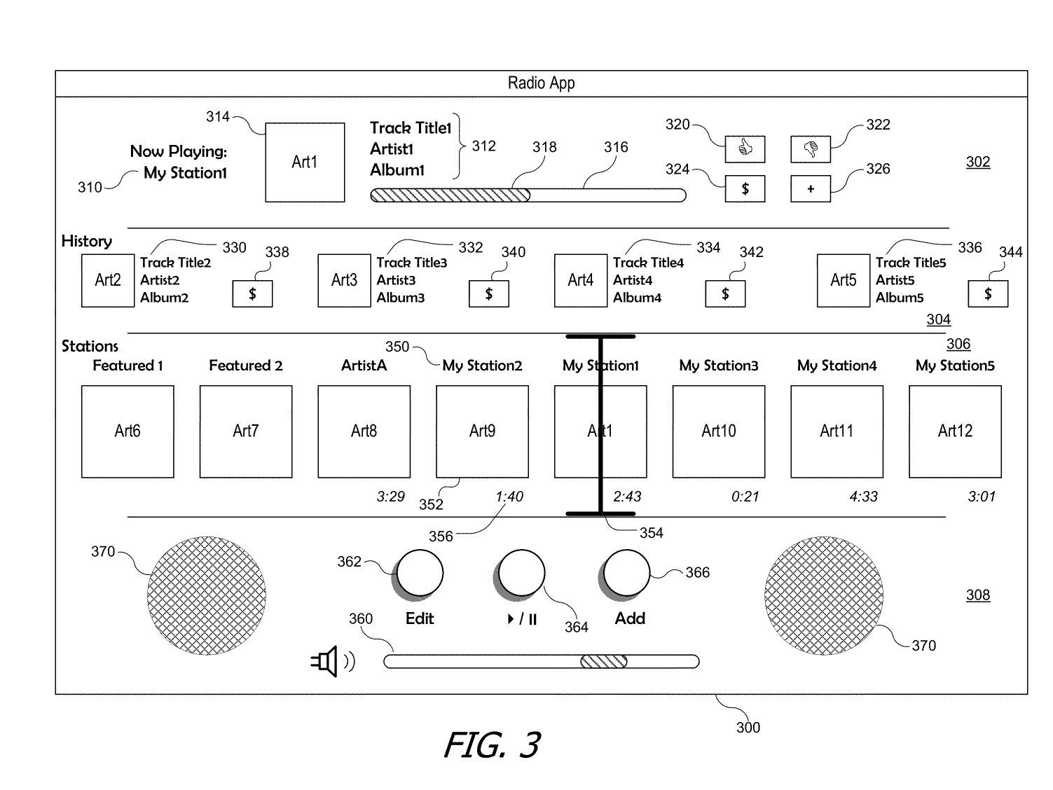

FIG. 3 illustrates a graphical user interface (GUI) 300 for a radio application according to an embodiment of the present invention. Radio GUI 300 can be implemented, e.g., on client device 102 of FIG. 1 executing radio application 145. In some embodiments, radio GUI 300 is optimized for a touchscreen input/output device, and a user can invoke functionality of radio GUI 300 by touching relevant areas of the screen on which GUI 300 is displayed using a finger, stylus, or the like. In other embodiments, radio GUI 300 can be operated using a pointing device (e.g., a mouse, pen, or trackpad) or other input devices.

Radio GUI 300 provides four regions: a now-playing region 302, a history region 304, a stations region 306 and a control region 308.

Now-playing region 302 provides information about the currently playing station and track. For example, a station name 310 can be prominently displayed, along with track identifying information 312 (e.g., track title, artist name, and album name) and artwork 314 associated with the currently playing track. As described above, track information 312 and artwork 314 can be obtained from radio server 104, along with the content of the track. Progress bar 316 can be used to represent the progress of playing the track, with filled region 318 gradually advancing to fill in progress bar 316.

Now-playing region 302 can also include control buttons that allow the user to interact with the currently playing track. By way of illustration, radio GUI 300 includes “Like” button 320, “Dislike” button 322, “Buy” button 324, and “Create” button 326. A user can actuate Like button 320 to indicate that she likes the currently playing track and wants to hear more tracks like it or actuate Dislike button 322 to indicate that she dislikes the currently playing track and wants to hear fewer tracks like it. In some embodiments, user feedback provided via buttons 320 and 322 can be used to dynamically modify the station playlist for the currently playing station (e.g., adding tracks similar to a track the user likes or removing tracks similar to a track the user dislikes) and/or to modify the algorithm(s) used to generate playlists for the current station and optionally other stations as well.

“Buy” button 324 allows the user to purchase the currently playing track, e.g., adding it to local media library 148. In general, radio system 100 is not limited to playing tracks the user owns, and the fact that a track is played on a station of radio system 100 does not give the user any additional rights to listen to the track. By touching Buy button 324, the user can purchase rights to the track (e.g., rights to listen at any time and/or on any device owned or operated by the user).

For example, radio application 145 can interoperate with a media library management application on client device 102 (e.g., the iTunes® software provided by Apple Inc., assignee of the present application), which can interact with a media store platform (e.g., the iTunes Store operated by Apple Inc.). When a user actuates Buy button 324, radio application 145 can generate a purchase request to the media store platform, either directly or via the media library management program, and the media store platform can fulfill the purchase request. In some embodiments, the user credentials associated with a particular user by radio application 145 are the same as the credentials associated with that user by the media store platform, and this can facilitate seamless purchase of a track. Purchased tracks can be downloaded to the user's local media library 148. In some embodiments, the user's media library may be cloud-based, and downloading is not required; any process by which the user is granted rights to the track can be used to complete a purchase.

In some embodiments, Buy button 324 can display the actual price of the track. In other embodiments, the price can be displayed after the user actuates Buy button 324, and another user input (e.g., actuating a confirmation button or actuating Buy button 324 again) can be required to complete the purchase.

Create button 326 allows the user to create a new radio station using the current track as the seed song. The user can be prompted for information further defining the new station (e.g., a station name), or the station name can be automatically generated. In some embodiments, an icon representing the new station can appear in station region 306, e.g., next to the current station, and the new station can be immediately selected as current. When a new station is created, radio application 145 can provide a station definition (e.g., an identifier of the seed song, in this case the currently playing track) to radio server 104 and obtain a starting playlist for the new station; this can be done in the background while the current track continues to play.

Other controls for interacting with a currently playing track can also be provided. For example, in some embodiments, navigation controls can be provided to restart the track from the beginning or skip ahead to the next track. Other examples include rating buttons, options to access additional information about the track or artist, options to view content related to the current track (e.g., a particular album or artist) in a media store application, and so on.

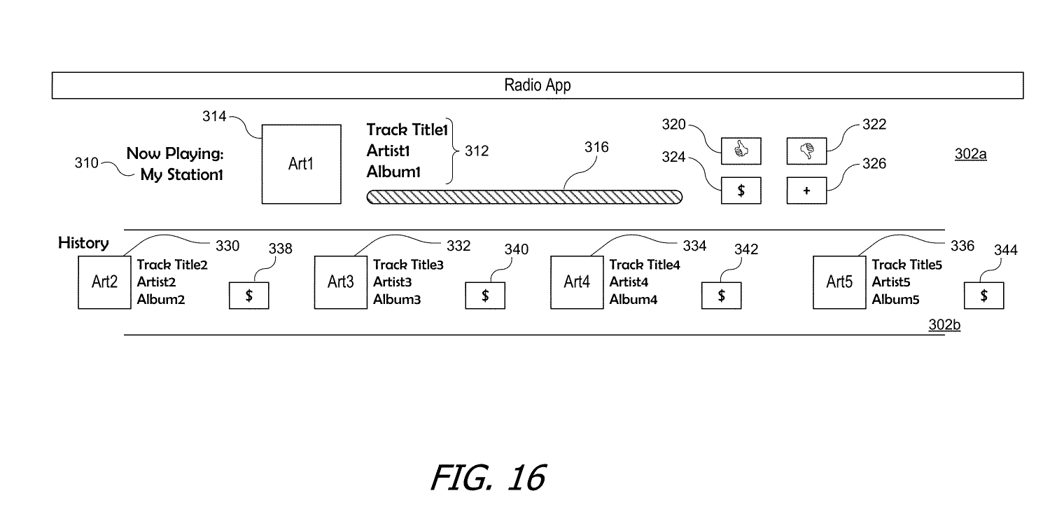

History region 304 can provide information about recently played tracks. In some embodiments, tracks are displayed in reverse chronological order, with the most recently played track 330 at the left and increasingly less recently played tracks 332, 334, 336 to the right. As described below with reference to FIGS. 16-18, animated transitions can be used to update regions 302 and 304 when a current track finishes playing and moves from region 302 to region 304.

In some embodiments, a Buy button 338, 340, 342, 344 is associated with each of recent tracks 330, 332, 334, 336. A user can touch one of Buy buttons 338, 340, 342, 344 to purchase the corresponding track. The purchase mechanism can be the same as that described above for the currently playing track (Buy button 324).

It is possible that some or all of the tracks in now-playing region 302 and/or history region 304 are already owned by the user. Where a track is owned by the user, the corresponding Buy button can be rendered in an inoperable state (e.g., grayed out), not rendered at all, or replaced with another option, e.g., to switch from radio application 145 to the user's media library management application to play the track there instead.

Stations region 306 allows the user to browse stations associated with the user's account on radio server 104 and to select a station to play. In some embodiments, each station is represented by a station icon that includes a station name (e.g., label 350) and an associated image (e.g., artwork 352). The currently playing station can be marked by a slider bar 354, which can be reminiscent of a frequency indicator on a traditional broadcast-radio receiver.

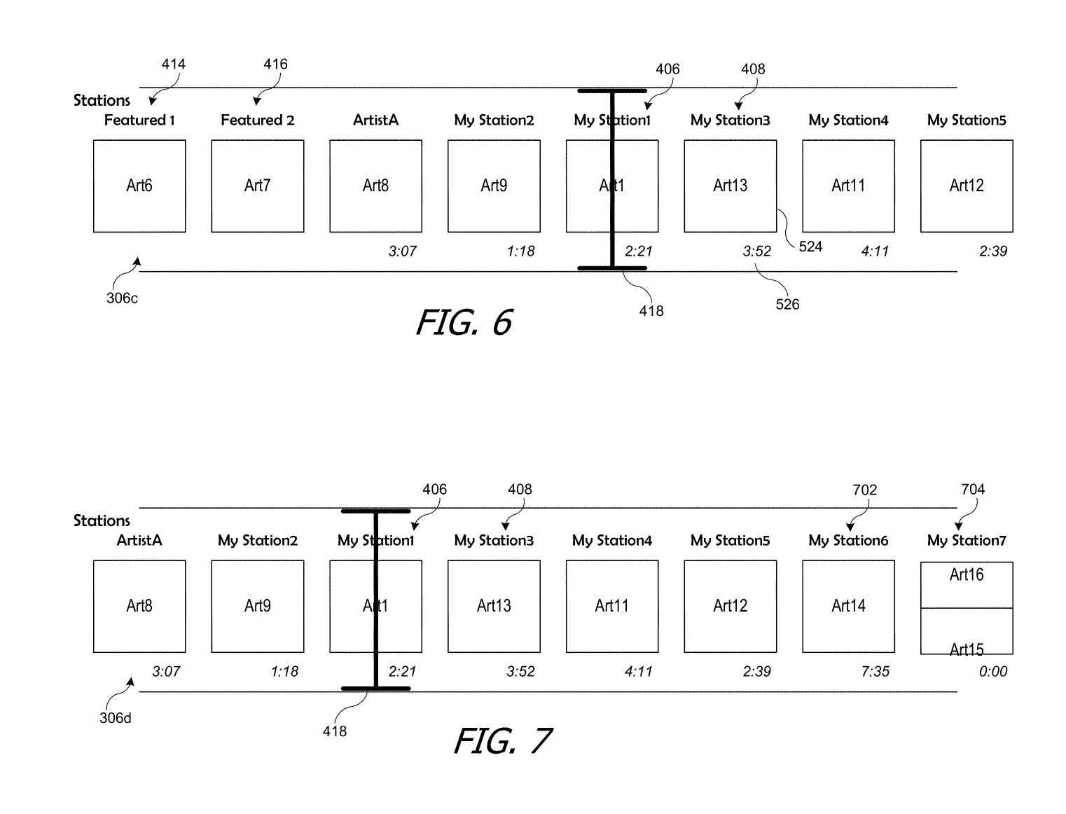

In some embodiments, a user can browse stations by scrolling the row of station icons to the right or left and can select a station by tapping or double-tapping on the corresponding icon. When the row of station icons is scrolled, slider bar 354 can move together with the current station icon (even moving off screen). When a new station is selected, slider bar 354 can move to mark the corresponding station icon. Station browsing and station selection are described further below with reference to FIGS. 6-9.

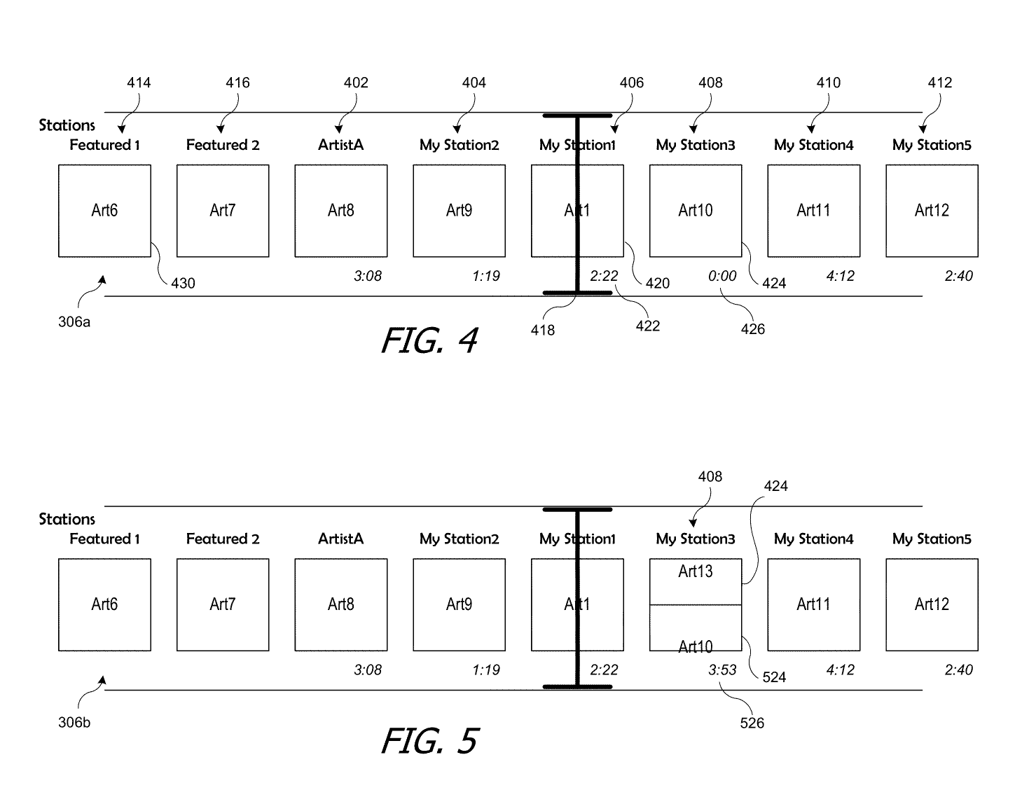

Some or all of the station icons in region 306 can be dynamic icons that create the impression that the stations are actually playing tracks even when they are not the current station. This effect is referred to herein as “virtual” playback. For example, image 352 can be associated with a current track from the corresponding station's playlist (i.e., the playlist for the station “My Station2”), and timer 356 can update in real time to count down the remaining duration of the current track. When timer 350 reaches zero, the next track in the “My Station2” playlist can become current and begin to “play.” At that point, image 352 can be changed to an image associated with the new current track while countdown timer 356 is reset to reflect the duration of the new current track and begins to count down again. In this example, “My Station2” is not the current station, and tracks from its playlist are not actually playing—that is, audio for these tracks is not being streamed and output to the user. Instead, the durations of the tracks in the playlist are used to set countdown timer 356 and select artwork to be displayed. Virtual playback is described further below with reference to FIGS. 4-6 and 10-15.

Control region 308 provides additional controls for interacting with radio application 145. Volume control 360 can be implemented as a slider, dial or any other control that allows the user to adjust the volume to a desired level. Other controls (not shown) related to audio output can be provided, such as equalizer settings, stereo balance, and the like.

Play/pause button 364 allows the user to pause and resume playback of audio content. In some embodiments, pausing playback using button 364 can also pause the virtual playback on stations other than the current station. Alternatively, virtual playback can continue while just the current station is paused.

Edit button 362 allows the user to bring up an interface for editing the station list and/or definitions of particular stations. For example, actuating edit button 362 may bring up an overlay window or new screen (not shown) that allows the user to delete stations or rearrange the stations into a desired order. The editing interface may also allow the user to edit settings for a particular station, e.g., the currently playing station. For example, the user can adjust the station definition.

Add button 366 allows the user to add a station. In some embodiments, actuation add button 366 may bring up an overlay window or new screen (not shown) that allows the user to define desired characteristics of the station, to browse featured stations, or the like. A new station created using Add button 366 can but need not use the currently playing track as a seed song.

Creating and editing of stations can be implemented as desired, and these operations can be generally independent of virtual playback and other features described herein. Accordingly, a detailed description of interfaces for station creation and editing is omitted; descriptions of suitable interfaces can be found, e.g., in above-referenced Provisional Application No. ______ (Attorney Docket No. 90911-P17497USP1-854235) and Provisional Application No. ______ (Attorney Docket No. 90911-P17545USP1-855374).

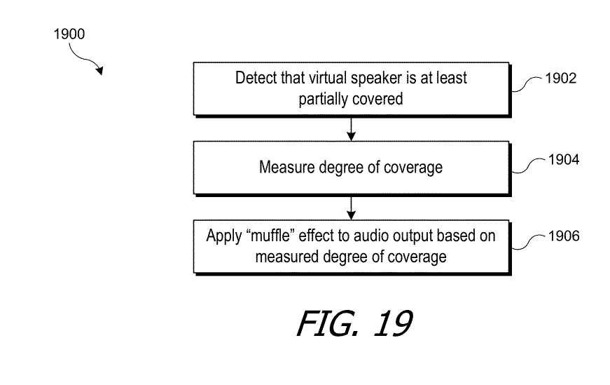

Speaker images 370 can be provided for esthetic effect, to further suggest the appearance of a radio. It is to be understood that speaker images 370 can simply be visual renderings representing speakers. In some embodiments, speaker images 370 can be non-functional decorative elements. In other embodiments, a user can interact with speaker images 370 to produce audio effects; examples are described below with reference to FIG. 19.

As described above, certain embodiments of the present invention relate to virtual playback for stations other than the current station. Virtual playback can contribute to the user's experience of the streaming radio application as a “radio” by having stations other than the current station appear to progress through their playlists. The effect can be produced by updating artwork associated with various stations, regardless of whether audio for these stations is being streamed. In some embodiments, audio is streamed only for the current station. For other stations, a countdown timer (or other progress indicator) is used to suggest that tracks are being played, and when the timer indicates that a track on a particular station has reached the end, the artwork and countdown timer for that station can be reset to suggest that the next track for that station is now being played. If a user changes stations by selecting a station that is operating in virtual playback mode, the selected station can begin by playing the track corresponding to the currently displayed artwork (either at the beginning or from the point indicated by the countdown timer). Specific examples will now be described.

FIG. 4 illustrates stations region 306a of a user interface for radio application 145 according to an embodiment of the present invention. Stations region 306a in this example corresponds to stations region 306 of FIG. 3, at a time 21 seconds later than the illustration of FIG. 3. Visible in stations region 306a are icons for dynamic stations 402, 404, 406, 408, 410, 412 and static stations 414, 416. (As used herein, a “dynamic” station is a station for which virtual playback is implemented; a “static” station is a station for which virtual playback is not implemented.) Station 406 is the current station, as indicated by slider bar 418, and radio app 145 is streaming and playing audio from the current track, identified by artwork 420. (The same track can also be identified in now-playing region 302 as shown in FIG. 3.) Countdown timer 422 indicates that two minutes and twenty-two seconds remain in the current track.

In this example, station 408, which is not the current station, is “virtually” playing a track identified by artwork 424. To indicate progress, a countdown timer 426 for the virtually-playing track is shown. It is to be understood that audio for the track on station 408 need not be streamed to or processed by radio application 145; countdown timer 426 can advance in real time, even in the absence of audio data.

FIG. 4 shows that countdown timer 426 has reached zero. Accordingly, station 408 can switch to virtually playing a next track from its playlist. FIG. 5 illustrates a transitional state as stations region 306b. In this transitional state, artwork 424 (for the completed track) is sliding upward and out of the top of artwork area of station icon 408 while artwork 524 (which corresponds to the next track) is sliding upward from below into the artwork area of station icon 408. The effect can be an animated transition similar to a number advancing on a car's odometer. Countdown timer 526 is set (to 3:53 in this example) based on the duration of the next track.

FIG. 6 illustrates stations region 306c at the end of the transition. Artwork 524 occupies the artwork area of station icon 408, and countdown timer 526 has begun to count down the duration of the new track. In some embodiments, radio application 145 does not begin to stream the audio for the new track on station 408 but rather continues to stream the audio for the track playing on current station 406, which is not affected by changing the virtually playing track on station 408.

It will be appreciated that the virtual playback effect as shown is illustrative and that variations and modifications are possible. For example, the rolling transition illustrated in FIGS. 4-6 can be replaced with a different transition (e.g., dissolve, cross-fade, wipe, expansion of the new icon to cover the old, rolling in a different direction, etc.). In some embodiments, the user can select a desired transition effect, e.g., using a settings menu. It is also possible for different transition effects to be used for different transition events; a transition effect can be randomly selected or applied as a per-station setting. The speed of transitions can also be varied. Thus, while FIGS. 4-6 may suggest a transition taking about a second (based on the progress of various countdown timers), the actual transition speed is a matter of design choice and can be faster or slower as desired.

The countdown timer can also be modified or replaced. For example, a timer counting up can be used instead, or both countdown and count-up timers can be shown (e.g., one above the artwork and one below, or count-up on the left and countdown on the right). A progress bar or other graphical indicator of progression of playing a track can also be used in addition to or instead of numerical timers. In some embodiments, a progress indicator is not displayed, but artwork transitions can still occur based on the duration of virtually playing tracks.

It is not required that virtual playback be implemented for every station. For example, FIG. 4 shows a combination of dynamic stations 402-412 and static stations 414, 416. Virtual playback is implemented for dynamic stations 402-412, as can be seen from the countdown timers, but not for static stations 414, 416, which do not display countdown timers. A static station, such as station 414, can display the same artwork 430 at all times, at least while it is not the current station. In some embodiments, user-created stations can be dynamic stations, while stations defined by radio server 104 (e.g., sponsored stations or other featured stations as described above) are static stations. The artwork for a static station (e.g., artwork 430 in FIG. 4) can include an advertisement, logo, or other graphical element. In some instances, the artwork can be indicative of a station theme, e.g., a dumbbell graphic for a “workout mix” station, an image of an artist whose work is featured on the station, and so on. In a particular implementation, any combination of static and dynamic stations can be supported.

In some embodiments, a particular station may switch from static to dynamic behavior depending on circumstances. For example, if it is desirable to operate at reduced power, virtual playback can be disabled for all stations, and each station (other than the current station) can display a static artwork image. As another example, if limited bandwidth or other network constraints are restricting the ability of client device 102 to download artwork, virtual playback can be disabled while such conditions persist. As yet another example, a featured station can be static while it is not the current station and switch to dynamic behavior if it becomes the current station.

A user can browse and change stations at any time, including while virtual playback is in progress. As described above with reference to FIG. 3, a user can browse stations in radio GUI 300 by scrolling the row of station icons in stations region 306 to the left or right. Particular interface controls for scrolling can be implemented as desired, depending on the input devices available. For example, on a touchscreen display, dragging a finger to the left (or right) correspondingly moves the icons to the left (or right); fast-drag or flicking gestures can also be defined to allow faster movement through a list of stations. A scroll bar or other scrolling controls (not shown) can also be provided.

FIG. 7 illustrates stations region 306d of a user interface for radio application 145 according to an embodiment of the present invention. Stations region 306d shows an effect of scrolling the stations row to the left relative to region 306c of FIG. 6. Station icons 414, 416 have scrolled off the left edge and are no longer visible. Station icons 702 and 704 (the latter of which happens to be in transition between virtually playing tracks when it becomes visible) have become visible at the right side. In the embodiment shown, scrolling the station list does not change the current station; accordingly, slider bar 418 moves together with station icon 406 (the current station). It is to be understood that, in radio GUI 300 of FIG. 3, scrolling of station region 306 need not affect any other region of GUI 300.

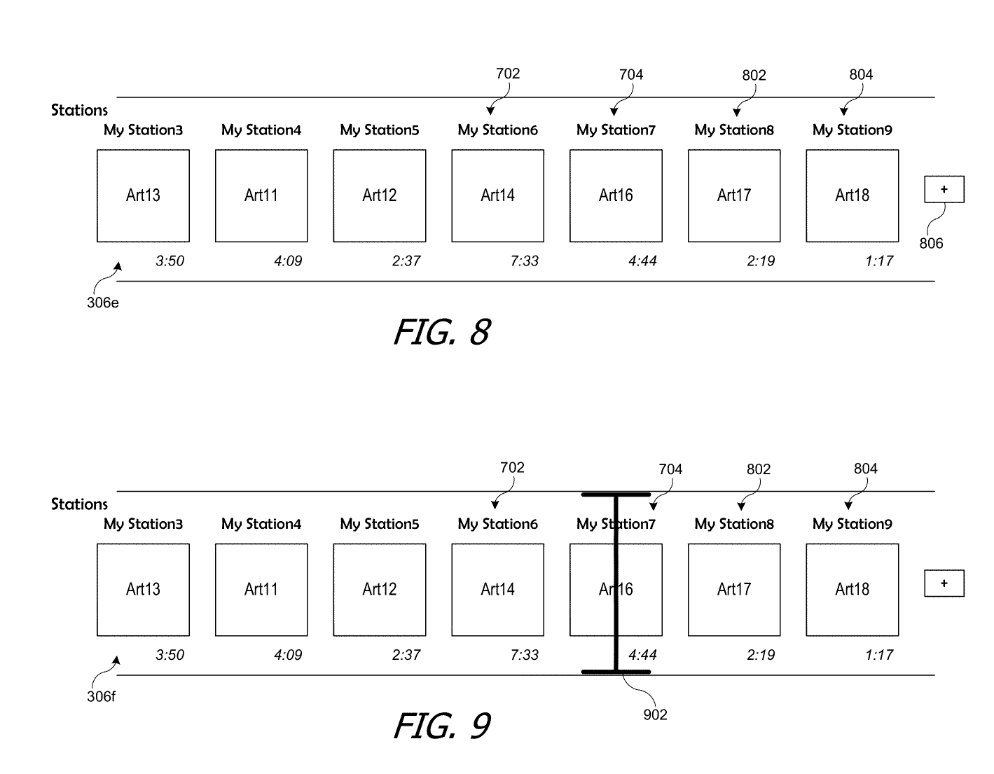

FIG. 8 illustrates stations region 306e, which corresponds to region 306d of FIG. 7 after further scrolling to the left. Current station icon 406 has scrolled off the left edge, and slider bar 418 has scrolled off the left edge with it. Additional station icons 802 and 804 have become visible at the right side of region 306e. Although current station icon 406 is not visible, the user can still identify the current station, e.g., by reference to now-playing region 302 of interface 300 (FIG. 3). In addition, some embodiments can provide a control element operable by the user to bring the current station back into the visible area of stations region 306 (e.g., by automatically scrolling the list until the current station reaches a designated point within the visible area).

In this example, station 804 is the last station in the user's stations list. Add button 806 can be provided next to station 804, indicating that additional stations can be added. Actuating add button 806 can bring up the same overlay window or interface screen as actuating add button 366 of FIG. 3. While add button 806 can provide a visual cue that the end of the station list has been reached; other visual cues can also be provided in addition to or instead of add button 806. For example, attempts to scroll further to the left from the position shown FIG. 8 may produce a rubber-band effect, with the icons moving further left, then snapping back to the position shown. A blank area can be displayed in place of add button 806, or a non-functional “end of list” indicator image can be displayed. Any or all of these features can also be implemented at the beginning of the list and can appear at the left side of stations region 306 when the user scrolls to the beginning of the list.

In some embodiments, a user can select any station visible in region 306 as the new current station, e.g., by tapping or clicking on its icon. FIG. 9 illustrates stations region 306f, which corresponds to region 306e of FIG. 8 after the user has selected station icon 704. Slider bar 902 marks station 704 as the current station. In some embodiments, slider bar 902 can be animated to slide from the previously selected station to the newly selected station. If the previously selected station is off screen, as in FIG. 9, the animation can show slider bar 902 entering from the side of the screen (left side in the case of FIG. 9) and sliding to a stop over station icon 704. Animated movement of slider bar 902 can be accompanied by a sound effect, such as garbled or staticky sounds reminiscent of sounds produced when changing the station on a broadcast radio tuner, with audio for the new station beginning approximately when slider bar 902 arrives at the new station.

When a user selects a new station, other parts of radio GUI 300 of FIG. 3 can also be updated. For example, now-playing region 302 can be updated to identify the new station at 310. Track information 312, artwork 314, and progress bar 316 can also be updated. History section 304 can be updated with information about the track that was playing immediately prior to the change of station. In addition, radio application 145 can switch to streaming audio from the new current station. If the new current station was virtually playing a track, the audio streaming can start with that track (either at the beginning or from the timepoint corresponding to the countdown timer, depending on implementation). This can further the radio-like experience for the user.

Radio application 145 can implement the virtual playback experience by maintaining and advancing through a playlist for each dynamic station. For example, at initialization time or at regular intervals (e.g., once per day), radio application 145 can communicate with radio server 104 to obtain a starting playlist for each dynamic station, e.g., using process 200 of FIG. 2 described above. The starting playlist can have just a few tracks (e.g., ten or twelve tracks), enough to create the impression that the station is playing different tracks at different times. As part of the starting playlist, radio server 104 can provide basic information about each track, such as track title, artist, a track identifier (for retrieving the track content), an artwork identifier, and a track duration. Radio application 145 can store this information for each dynamic station.

During operation, radio application 145 can repeatedly loop through the starting playlist for each station other than the current station, virtually playing each track in turn by displaying the artwork and operating a countdown timer for the duration of the track. When the end of the starting playlist is reached, radio application 145 can return to the beginning. While looping a playlist of a dozen or so tracks may provide a higher repetition rate than would be desirable if the user were actually listening to the station, it can be sufficient to create an impression of activity for stations the user is not listening to.

When the user changes the station, radio application 145 can expand (or refresh) the playlist for the newly selected station while beginning to play the current track from the starting playlist. For example, radio application 145 can communicate with radio server 104 to request an expanded (or refreshed) playlist for the station. The expanded (or refreshed) playlist can include, e.g., enough content for 24 hours of continuous listening (at a typical track length of 5 minutes, this would be almost 300 tracks, but no particular number of tracks is required). The expanded playlist can be added to or substituted for the starting playlist while continuing to play the current track; any change in playlist can be undetectable by the user. In some embodiments, the starting playlists do not include advertisements, while expanded playlists can include advertisements.

It is plausible that a user may define a large number of stations (e.g., a hundred or more). Due to various resource constraints, it may not be desirable for radio application 145 to maintain virtual playback for all stations at once. Accordingly, in some embodiments, radio application 145 can assign each of the dynamic stations (i.e., stations for which virtual playback is used) to one of three status options: current, virtual, and inactive. The “current” station is the station the user has selected for listening. “Virtual” stations are stations other than the current station for which virtual playback should continue to progress. This can include any dynamic stations visible in stations region 306 as well as a “buffer” region of dynamic stations that are near but not in the visible area of stations region 306 (e.g., 10 or 20 stations to either side of the visible area), determined from the order of the stations list. “Inactive” stations are dynamic stations, other than the current station, that are not in the visible area or the buffer region and are therefore considered less likely to become visible in the near future. For inactive stations, virtual playback can stop or pause.

For the current station, radio application 145 can stream the audio, display information in now-playing region 302 of GUI 300, and update a countdown timer and artwork in stations region 306 of GUI 300.

For virtual stations, radio application 145 can update countdown timers and artwork in stations region 306 of GUI 300. If a virtual station is not visible, the timer and artwork are not displayed, but the information can be stored in readily-accessible areas of memory so that it can be displayed without noticeable delay if the station becomes visible.

For inactive stations, radio application 145 can pause the virtual playback, e.g., by letting the current countdown timer run out and advancing to the next track, but not advancing the countdown timer through the next track. This pause will likely not be noticed by the user, since inactive stations are by definition not visible. If the station transitions virtual or current status, virtual (or actual) playback can be resumed.

Examples of processes for managing virtual playback for current, virtual, and inactive stations will now be described. These processes can be implemented, e.g., as executable program instructions in radio application 145. In the description below, it is assumed that radio application 145 has already obtained station information, including a starting playlist for each station, from radio server 104 (e.g., using process 200 of FIG. 2). As noted above, the starting playlist can provide information about each track, such as a track identifier, track duration, and identifier of an artwork image associated with the track.

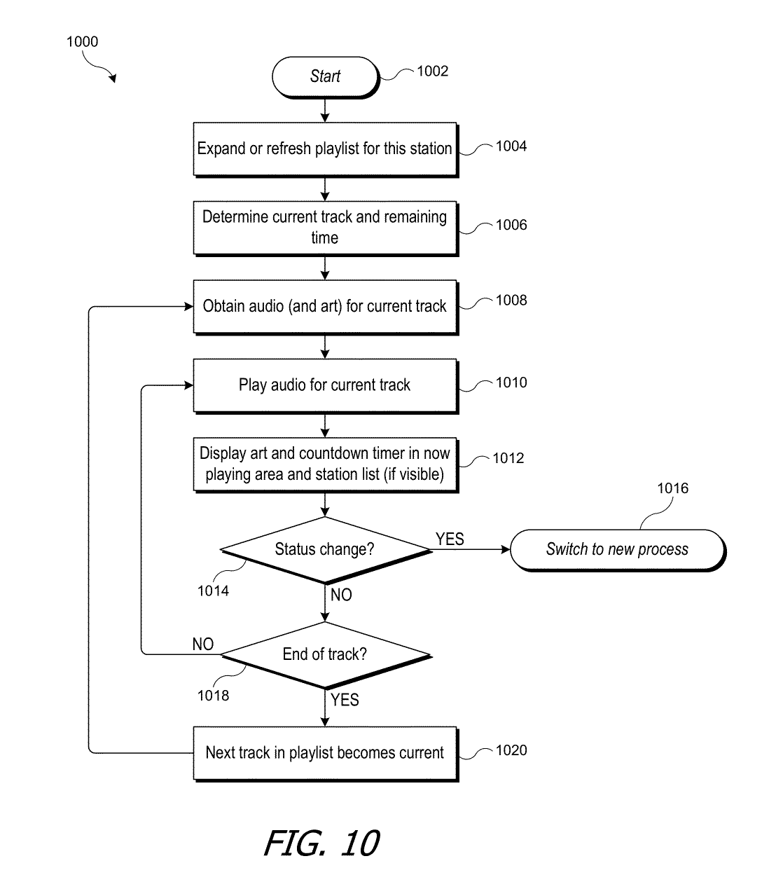

FIG. 10 is a flow diagram of a process 1000 for managing playback for a current station according to an embodiment of the present invention. Process 1000 begins (start block 1002) when a station is first selected as current. Selection of a current station can occur during initialization of radio application 145 (e.g., returning to the station that was current when the application last exited or selecting a default starting station) or in response to user input selecting a station during operation of radio application 145, e.g., as described above.

At block 1004, process 1000 can send a request to radio server 104 to expand or refresh the playlist for the newly selected current station. As described above, expanding the playlist can include identifying additional tracks to supplement or replace the tracks of the starting playlist; refreshing can be similar but can start from a playlist that has already been expanded. Process 1000 need not wait for a response before proceeding, as the starting playlist can be used to begin playback.

At block 1006, process 100 can determine the current track and remaining time. If the station was previously performing virtual playback, the current track can be the track that was being virtually played. If not, the current track can be the next track on the station's starting playlist.

At block 1008, process 1000 can obtain the audio and artwork for the current track. Audio can be obtained, e.g., by requesting an audio stream from radio server 104 and providing the track identifier. In some instances (e.g., if the current station was virtually playing prior to being selected as current), radio application 145 may already have the artwork for the current track. If not, radio application 145 can request the artwork from radio server 104 using the associated artwork identifier.

At block 1010, process 1000 can begin playing the audio for the current track, and at block 1012, the corresponding artwork and countdown timer (or progress bar) can be displayed in now-playing region 302 (FIG. 3) and also in stations region 306 if the current station is visible in that region. In some embodiments, if the station was previously performing virtual playback audio can begin in mid-track, at a time point determined from the countdown timer. Alternatively, when a station is selected, audio playback can restart from the beginning of the track.

At block 1014, process 1000 detects whether a status change has occurred for the current station (e.g., whether the user has changed the current station). If a station change occurs, the station that was current becomes either virtual or inactive (depending on where its icon is in relation to the visible portion of the station list), and at block 1016, processing for the (formerly) current station can switch to a different process (e.g., process 1100 or 1200 described below) depending on the station's new status. Concurrently, process 1000 can restart with the newly selected station as the current station. If, at block 1014, the current station has not changed, process 1000 can continue to block 1018.

At block 1018, process 1000 detects whether the current track has ended. If not, process 1000 continues to play the current track and advance the countdown timer (or progress indicator) until either a status change event or end of track is detected. At block 1020, if the current track ends, the next track in the playlist (which can be either the starting playlist or the expanded playlist requested at block 1004) is selected as current, and process 1000 returns to block 1008 to play the next track. A station can continue to be processed as the current station using process 1000 until such time as the user changes the station or radio application 145 exits. It may be desirable to periodically (e.g., once per day) refresh the playlist in order to reduce repetition of tracks over long periods of listening.

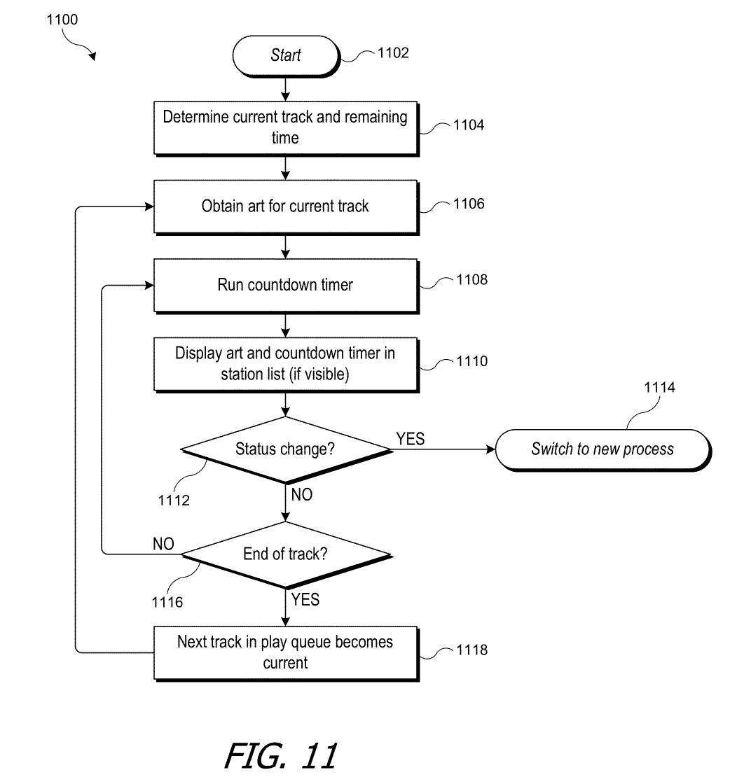

FIG. 11 is a flow diagram of a process 1100 for managing virtual playback for a virtual station according to an embodiment of the present invention. In some embodiments, process 1100 can be used for each station that is not the current station but that is either currently visible in station region 306 or within a buffer region near the visible region as described above.

Process 1100 begins (start block 1102) when a station transitions to virtual status. For example, the current station can become virtual if the user selects a nearby station in region 300 as a new current station, or an inactive station can become virtual if the user scrolls station region 300 such that the inactive station enters the visible area or the buffer region as described above.

At block 1104, process 1100 can determine the current track and remaining time for the virtual station. If the station was the current station prior to its transition to virtual status, the current track and remaining time can be determined based on the state of playback at the time when the user changed the station. If the station was not previously the current station (e.g., the station was inactive or radio application 145 is newly initialized), the current track can be the next track on the station's starting playlist.

At block 1106, process 1100 can obtain the artwork for the current track. In some instances (e.g., if the station was the current station prior to transitioning to virtual status), radio application 145 may already have the artwork for the current track and no action would be needed to obtain it. If not, radio application 145 can request the artwork from radio server 104 using the associated artwork identifier.

At block 1108, process 1100 can run a countdown (or count-up) timer for the current track. The timer can be initialized based on the track duration, or if the station was the current station prior to transitioning to virtual status, the timer can continue from the point at which the user changed the station.

At block 1110, the artwork and countdown timer (or other progress indicator) can be displayed in stations region 306 (FIG. 3) if the virtual station is visible in that region. If not, nothing is displayed for the virtual playback, but the countdown timer continues to run. Process 1100 need not include obtaining audio, since the audio is not played for virtual stations.

At block 1112, process 1100 detects whether a status change has occurred for the virtual station. For instance, if the user changes station to the virtual station, the virtual station becomes current. As another example, if the user scrolls the station list such that the virtual station moves off screen and out of the buffer region, the virtual station can become inactive. If a status change has occurred, then at block 1114, processing for the (formerly) virtual station can switch to a different process (e.g., process 1000 described above or process 1200 described below) depending on the station's new status. If, at block 1112, the station remains in virtual status, process 1100 can continue to block 1116.

At block 1116, process 1100 detects whether virtual play of the current track has ended (e.g., whether the countdown timer has reached zero). If not, process 1100 continues to virtually play the current track (e.g., advance the countdown timer) until either a status change or end of track is detected. At block 1118, if the current track ends, the next track in the playlist is selected as current, and process 1100 returns to block 1106 to virtually play the next track.

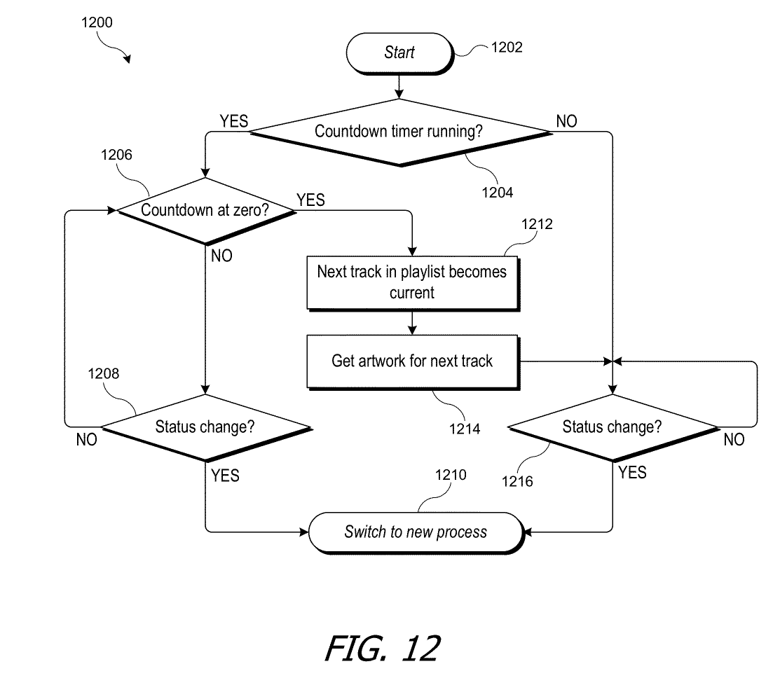

FIG. 12 is a flow diagram of a process 1200 for managing virtual playback for an inactive station according to an embodiment of the present invention. In some embodiments, process 1200 can be used for each station that is not the current station and is also neither visible in station region 306 nor located within a buffer region near the visible region as described above.

Process 1200 begins (start block 1202) when a station transitions to inactive status. For example, if the user scrolls station region 306 so that a station that was virtual is far enough off screen (outside the buffer region), the station may transition from virtual to inactive status. As another example, if the user selects a new station while the current station is far enough off screen (outside the buffer region), the current station can transition directly to inactive status.

At block 1204, process 1200 determines whether the newly inactive station has a countdown timer running. For example, if a station was previously virtual or current, it would have a countdown timer running when it transitions to inactive status. A station that is classified as inactive on initialization of radio application 145 (e.g., based on an initial configuration of GUI 300 in which the current station is visible in region 306) would not have a countdown timer running when process 1200 begins.

If a countdown timer is running, process 1200 allows the timer to run to the end of the current track. For example, at block 1206, process 1200 determines whether the timer has reached zero. If not, then at block 1208, process 1200 detects whether a status change has occurred for the inactive station. For instance, if the user scrolls the station list such that the inactive station enters the visible region or the buffer region, the inactive station can become virtual. If a status change has occurred, then at block 1210, processing for the (formerly) inactive station can switch to a different process (e.g., process 1000 or 1100 described above) depending on the station's new status.

If, at block 1208, a status change does not occur, process 1200 can continue to let the countdown timer run until at block 1206, the timer reaches zero. At block 1212, the next track in the playlist for the inactive station becomes current, and at block 1214, process 1200 can obtain artwork for the next (now current) track.

Unlike process 1100 for virtual stations, process 1200 for inactive stations does not start virtual playback of the new track. Instead, at block 1216, process 1200 can simply wait until a status change occurs (e.g., the inactive station becomes virtual or current). If this occurs, then at block 1210, processing for the (formerly) inactive station can switch to a different process (e.g., process 1000 or 1100 described above) depending on the station's new status.

Radio application 145 can assign a status to each station, e.g., based on which stations are currently visible in stations region 306 of GUI 300 of FIG. 3, and can use the corresponding one of processes 1000, 1100, and 1200 to manage each station based on its status. The status of a station can change in response to a status-change event, which can occur when the user changes the station (selects a new station to be the current station) and/or when the user scrolls station region 306 to display different stations.

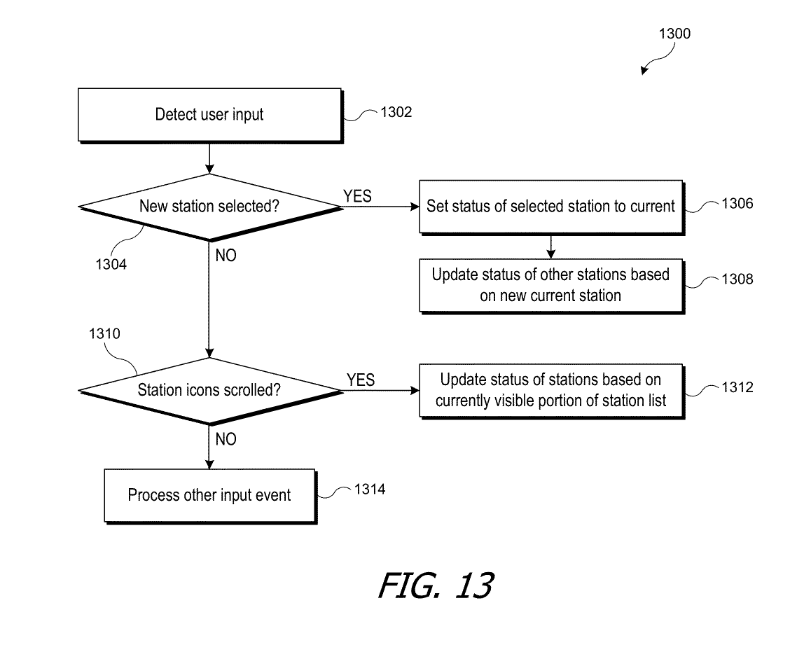

FIG. 13 is a flow diagram of a process 1300 for processing a status-change event according to an embodiment of the present invention. In this example, a status-change event occurs in response to user input, and process 1300 begins when user input is detected at block 1302.

At block 1304, process 1300 can determine whether the user input corresponds to selecting a new station. For example, as described above, a station can be selected by tapping its icon in station region 306; in various embodiments, other actions can also be interpreted as selecting a station.

If a new station is selected, then at block 1306, process 1300 can set the status of the selected station to current. This can cause process 1000 to be invoked for the new current station. At block 1308, process 1300 can update the status of other stations based on the new current station. For example, the station that was current prior to the new selection may become either virtual or inactive, depending on where it is in relation to the visible portion of stations region 306. The status of other stations may also be changed (e.g., between virtual and inactive) based on where they are in relation to the visible portion of station region 306.

If, at block 1304, the user input does not correspond to selecting a new station, then at block 1310, process 1300 can determine whether the user input corresponds to scrolling the station icons in station region 306. If so, then at block 1312, process 1300 can update the status of the stations based on the visible region after the scrolling. In some embodiments, scrolling does not affect the current station selection, and the current station can retain its status at block 1312. Other stations, however, may enter or exit the region of virtual stations, and their status may transition from inactive to virtual or vice versa.

At block 1314, process 1300 can process other types of user input events. As described above, user interaction with radio application interface 300 is not limited to station selection and scrolling, and block 1314 can include processing any other type of input, including station creation and editing, purchasing tracks, adjusting the volume, and so on. Such operations need not affect virtual playback, and a detailed description is omitted.

Using processes 1000, 1100, 1200, and 1300, radio application 145 can provide a virtual playback experience that can give the user a sense that all of the dynamic stations are always playing, even while the user is listening to another station. When the user selects a station, play can commence with the track that was being displayed immediately prior to selection, either from the beginning or from the time point indicated in the countdown timer associated with the station. It is not necessary that all the stations be playing (or virtually playing) at all times. For example, process 1200 can be used to, in effect, pause the playback for inactive stations, but the user does not see them as paused as long as inactive status is applied only when a station is invisible.

Providing a buffer of virtual stations that extends beyond the visible range can further enhance the sense that the stations are playing, in that stations will tend to appear in the visible range at different points within tracks and will appear to continue to play even if scrolled off screen. For instance, in the illustration of FIG. 7, station 704 first appears in mid-transition between two tracks while station 702 first appears somewhere in the middle of a track. Where the virtual stations include stations outside the visible portion of the station list, an inactive station (which may be paused) would transition to virtual status and begin or resume virtual playback before it becomes visible, making it less likely that the user would notice the statistically improbable event of having several stations beginning new tracks at the same time. If further realism is desired, process 1100 (for virtual stations) can be modified such that if an inactive station that is paused at the beginning of a track transitions to virtual status, the countdown timer can be initialized as if a portion of the track had already been played. The portion can be determined using a random, quasi-random, or pseudorandom process.

Processes 1000, 1100, and 1200 include obtaining audio and artwork for various tracks. The description above suggests that each audio track or artwork image can be separately requested. While this is an option, it may not be an optimal use of system resources. For example, if client device 102 of FIG. 1 communicates wirelessly with network 106, each separate request may involve powering up RF transceiver circuitry within client device 102 to transmit the request and receive the data. In some embodiments, transceiver usage can be reduced by looking ahead and coalescing requests for data associated with different stations.

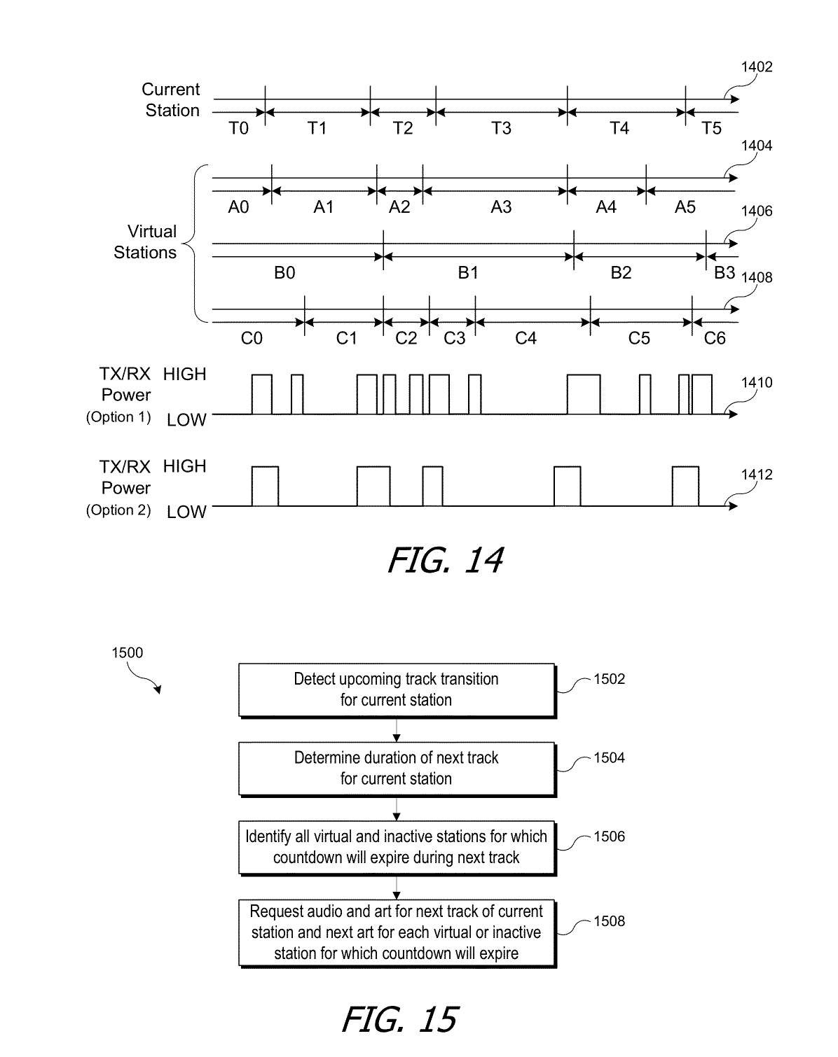

By way of illustration FIG. 14 is a timeline view illustrating transceiver usage according to some embodiments of the present invention. Timeline 1402 illustrates activity on a current station, which is playing tracks T0, T1, T2, T3, T4 and T5. Each track begins at the time indicated on timeline 1402. At the same time, virtual stations are virtually playing tracks as shown on timelines 1404, 1406, 1408, which represent virtual stations A, B and C.

In this embodiment, in order to play tracks T1-T5, radio application 145 obtains the audio and artwork by using a wireless interface to communicate with radio server 104 via network 106. In order to virtually play tracks A1-A5, B1-B3, and C1-C6, radio application 145 obtains the artwork (but not the audio) using the same wireless interface.

Radio application 145 can send a separate request for each track and artwork image. This results in a pattern of RF transceiver usage as shown in timeline 1410, where the transceiver is powered up shortly before the data is needed and remains on long enough to request and receive the data. As can be seen, the transceiver in timeline 1410 can spend a significant fraction of time in powered-up state. Because a wireless transceiver may consume significant power, this pattern of activity may not be desirable, particularly in a battery-powered device or other circumstance in which power consumption is a concern.

To reduce power consumption, radio application 145 can look ahead and coalesce requests for artwork across multiple stations with requests for audio data for the current station. FIG. 15 is a flow diagram of a process 1500 for coalescing requests according to an embodiment of the present invention. Process 1500 can be implemented, e.g., using program instructions in radio application 145.

At block 1502, process 1500 can detect an upcoming track transition for the current station, e.g., an upcoming transition from track T0 to T1 in timeline 1402. At block 1504, process 1500 can determine the duration of the next track for the current station, e.g., track T1. This determination can be based on track-duration data that was provided by radio server 104 as part of the playlist for the current station.

At block 1506, process 1500 can identify any virtual and/or inactive stations for which a countdown timer will expire before the end of the next track of the current station. For example, referring to timelines 1404, 1406, and 1408, it can be determined that the countdown timers for tracks A1 and C1 will expire while track T1 is playing. At block 1508, process 1500 can send a request to obtain the audio and artwork for the next track of the current station as well as artwork for any virtual and/or inactive stations for which a countdown timer will expire before the end of the next track of the current station.

A result of applying process 1500 is illustrated in FIG. 14 as timeline 1412. Shortly before track T1 begins playing, a first request R1 can be sent to obtain audio and artwork for track T1 and artwork for tracks A1 and C1. Shortly before track T2 begins playing, a second request R2 can be sent to obtain audio and artwork for track T2 and artwork for tracks A2, B1, C2 and C3. Shortly before track T3 begins playing, a third request R3 can be sent to obtain audio and artwork for track T3 and artwork for track C4. Shortly before track T4 begins playing, a fourth request R4 can be sent to obtain audio and artwork for track T4 and artwork for tracks A4, B2 and C5. Shortly before track T5 begins playing, a fifth request R5 can be sent to obtain audio and artwork for track T5 and artwork for tracks B3 and C6.

Each coalesced request can be sent at a time such that the audio will be returned in time for the next track on the current station to begin playing. In the response, transmission of audio data can be prioritized over artwork. With this arrangement, the wireless transceiver of client device 102 can be powered up once for each track on the current station and otherwise powered down (assuming the interface is only being used to support radio application 145). As can be seen by comparing timelines 1410, 1412, coalescing requests can reduce the amount of time the wireless transceiver is powered up and thereby reduce power consumption.

If a user changes stations in mid-track, a request for the audio for the new station can be coalesced with requests for artwork based on the duration of the track of the new station. Some of this artwork may already have been obtained prior to the station change and need not be requested again.

It should be understood that some embodiments, radio application 145 can maintain a local cache of artwork images previously obtained from radio server 104 and can use cached images where available. Requests for artwork need not be sent to radio server 104 if the artwork is cached; such caching can further reduce transceiver usage.

As described above with reference to FIG. 3, now-playing region 302 provides information about the track that is currently playing, and history region 304 provides information about previously played tracks. Once a track has finished playing, it can be moved from now-playing region 302 to history region 304. In some embodiments, the transition can be animated in a manner that is intuitive to the user and esthetically pleasing. One example of a transition effect is illustrated in FIGS. 16-18.

FIG. 16 shows now-playing region 302a and history region 304a of GUI 300 at the end of playing a track identified by track metadata 312 and artwork 314. Progress bar 316 is completely filled in, indicating the end of the track.

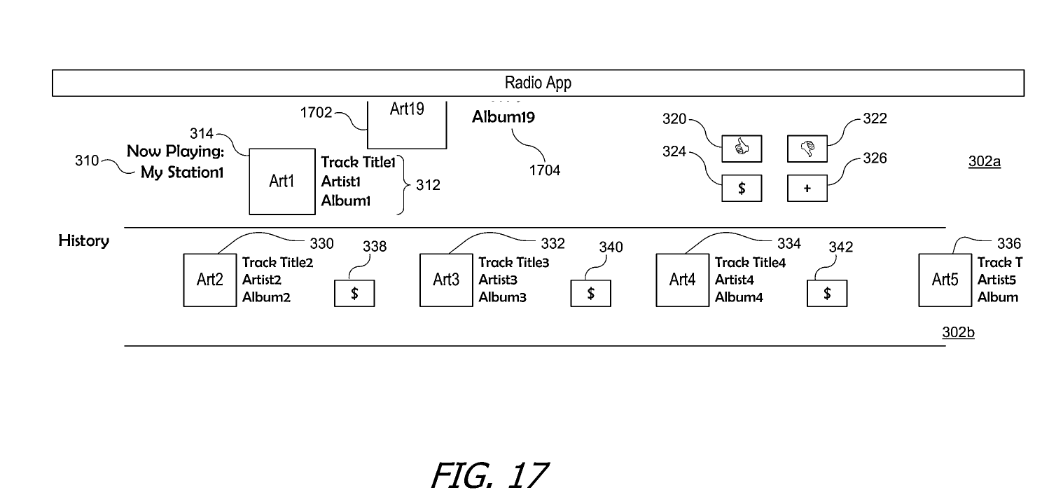

FIG. 17 shows now-playing region 302b and history region 304b of GUI 300 as the next track begins. In region 302b, information elements 312, 314 pertaining to the completed track are slightly reduced in size and have begun to shift down and toward the left. At the same time, information elements 1702, 1704 pertaining to the next track have begun to drop in from the top of the display area to replace elements 312, 314. Buttons 320-326 can be inactivated (shown as grayed out) during the transition. In region 304b, track information elements 330, 332, 334, 336 (including associated Buy buttons 338, 340, 342, 344) have begun to shift to the right, and element 336 has moved partially outside the visible region.

Information elements 312, 314 can continue to reduce in size and move down and toward the left, dropping into history region 304b in the space formerly occupied by element 330, which continues to shift to the right to create space, eventually shifting element 336 off screen.

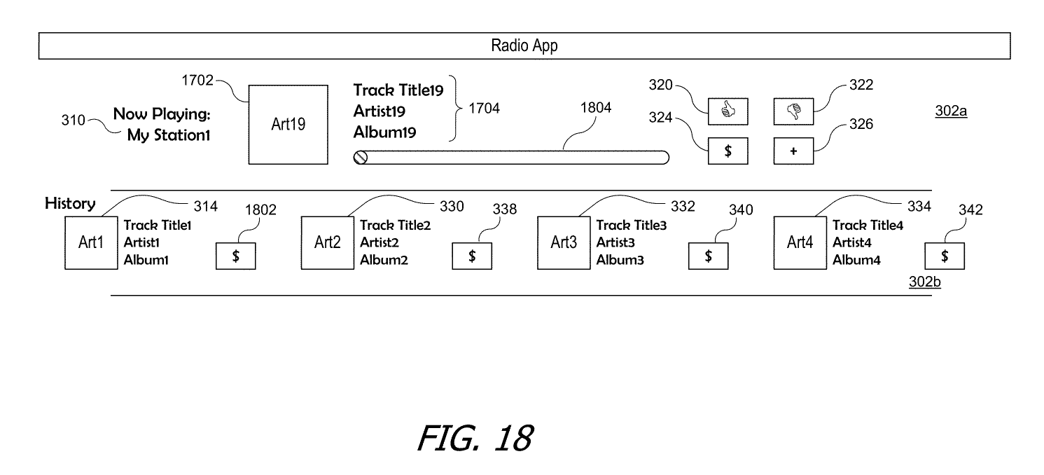

FIG. 18 shows now-playing region 302c and history region 304c of GUI 300 at the end of the track transition. Information elements 312, 314 for the just-played track have moved fully into history region 304c, where they appear at the head of the history list along with an associated Buy button 1802, while information element 336 has moved off screen. Information elements 1702, 1704 have moved into place in now-playing region 302c, and progress bar 1804 has appeared to indicate the progress of playing the new track. Buttons 320, 322, 324, and 326 are now associated with the new track.

The transition illustrated in FIGS. 16-18 is illustrative and can be modified. For instance, the history region can be oriented differently and/or positioned differently relative to the now-playing region, and track information can move appropriately to indicate the transition.

In some embodiments, a similar transition can occur any time radio application 145 switches tracks, including a switch in mid-track due to the user changing the station. In the event of a station change, station identifier 310 can be updated concurrently with the transition of the track information in the now-playing region. For instance, the old station name can roll out of view (e.g., appearing to move up under the words “Now Playing”) while the new station identifier rolls into view (e.g., from below).

History region 304 can provide an in-order listing of recently played tracks, regardless of which station played a particular track. Thus, changing stations need not clear tracks from history region 304. In some embodiments, the track information in history region 304 can include an identifier of the station that played the track. Other information can be included as desired. In some embodiments, history information can be cleared when radio application 145 exits, and when radio application 145 restarts, history region 304 would be empty. In other embodiments, history information can be persistently stored. For example, radio application 145 can store the information in local persistent storage on client device 102 and/or periodically transmit information identifying recently-played tracks to radio server 104, which can store the information with other user account data 152. Where history information is persistently stored, initializing radio application 145 can include retrieving history information from persistent storage and obtaining artwork and other data to populate history region 304.

Records of any number of previously-played tracks can be kept. In some embodiments, history region 304 can be scrolled to view (and purchase) less recently played tracks that are not initially visible. Any number of tracks can be presented in history region 304, either simultaneously or via scrolling. In keeping with the radio metaphor, some embodiments do not allow a user to select a track from history region 304 for playback. However, in embodiments where the user has a media library, radio application 145 may allow the user to select a track that is in the user's media library from history region 304 and thereby invoke a media application to play the selected track from the user's media library.

A radio user interface such as GUI 300 can also provide other features, such as volume adjustment, equalizer settings and the like, allowing the user to adjust the audio output based on individual preferences. Some features may be provided in order to further the sense that GUI 300 is a “real” radio interface. For example, if GUI 300 is implemented on a touchscreen display, it may be possible to detect when the user's hand or other objects are in proximity to or in contact with speaker images 370. If speaker images 370 were physical speakers, covering the speakers would affect the sound output, e.g., by making the sound quieter or muffled. In some embodiments, this effect can be recreated by altering the audio output based on detected coverage of speaker images 370.

FIG. 19 is a flow diagram of a process 1900 for altering sound output based on touch input according to an embodiment of the present invention. Process 1900 can be implemented, e.g., using program code in radio application 145.

At block 1902, process 1900 can detect that a speaker image is at least partially covered, e.g., by detecting that an object is in contact with or in proximity to a screen presenting GUI 300, and more particularly whether the object is in contact with or in proximity to an area where a speaker image 370 is displayed. At block 1904, process 1900 can determine a degree to which one or both speaker images 370 are covered, e.g., by comparing the detected area of contact or proximity to the area occupied by the speaker image(s). At block 1906, process 1900 can apply a “muffle” effect to the audio output based on the degree to which the speaker images are covered; a greater degree of coverage can produce a stronger “muffle” effect.

Various audio processing effects can be used to emulate muffled sound. For example, the overall volume of the sound can be reduced. In addition, certain audio frequencies can be preferentially reduced (e.g., reduce high frequencies more than low frequencies) to produce sounds similar to an obstructed speaker. The intensity of the effect can be varied based on the degree to which one or both speaker images 370 are covered. Such features can entertain the user and can also enhance the user's association of the radio GUI with a physical radio. Since the effect is produced by audio processing, the spatial relationship between the rendered speaker images and the device's actual speakers is not relevant.

In instances where a user interface on a device has a rendering of a microphone (not shown), audio processing effects can be used to muffle or mute input to the device's microphone input. For example, a user can mute a device's actual microphone by placing a finger or hand over a rendered microphone image and unmute the microphone by moving the finger or hand away from the rendered microphone image, regardless of the spatial relationship between the rendered microphone and the actual microphone.

While the invention has been described with respect to specific embodiments, one skilled in the art will recognize that numerous modifications are possible. For example, embodiments described above show GUI layouts with icons arranged in a horizontal row (e.g., for history or station browsing); however, different arrangements, such as vertical columns or 2-dimensional grids, can be substituted. Arrangements and labeling of elements can be varied, and different controls or combinations of controls can be used.

The description refers to “artwork” used as a visual indicator of what is playing (actually or virtually) on various stations. As used herein, artwork can include any type of image or visual indicator. For instance, in some embodiments, artwork can include all or part of an album cover or other image associated with the track, the artist, an album of which the track is part, or anything else. Text elements can also be used as artwork in addition to or instead of graphical elements; for example, the track title, artist name, album name or the like can be displayed.

The description also refers to playlists associated with various stations and describes playlists being generated at a server and transmitted to the client device. In some instances, the device can receive a playlist for a station and use the playlist to request specific tracks to be streamed while the station is playing, as well as to request associated artwork for stations that are playing or virtually playing. In other instances, the device can simply request the next track and/or next for a particular station and receive track-identifying information and associated artwork along with the media content for tracks that are actually being played. Thus, it is not necessary to deliver a playlist to the client device; the server can generate playlists and stream each track and/or deliver a next artwork image in turn. The playlist can be as long as desired; for instance, the server can generate a succession of one-track playlists for a station as each track is (actually or virtually) played or generate a longer playlist for the station and refer to that playlist when selecting tracks to (actually or virtually) play.

In some embodiments described above, it is assumed that the radio application obtains all audio and artwork from a radio server via a network. Some embodiments can use other sources in addition to or instead of the radio server. For example, a different remote server may provide audio and/or artwork via a network. As another example, in some instances, some or all of the audio and/or artwork may be stored in a user's media library on the client device or in a local cache. In such instances, the radio application can obtain audio and/or artwork from these sources.

In addition, while the description makes specific reference to radio and to audio tracks, those skilled in the art will appreciate that similar interfaces can be used in connection with presentation of other media. For example, in the case of a multi-channel video streaming application, a virtual channel can be represented by a still image from a virtually-playing video along with a progress indicator. A video-channel selection interface incorporating virtual channels can be provided, e.g., as a pop-up overlay over a currently playing video, in one region of a screen while the current video plays in a different region, or on a secondary display device (e.g., a remote control device) while the current video plays on a primary display device (e.g., a TV screen).

The description also makes reference to embodiments where a user has a media library. In such instances, the user's media library can be stored locally on the client device, or it can be stored remotely, e.g., in the cloud, and accessed by the client device based on a user account or the like. In some embodiments, the same user account or credentials can be associated with both the streaming media application and the user's cloud-based media library, to facilitate seamless interoperation with both.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A graphical user interface for a media application, the graphical user interface comprising:
a stations region displaying a plurality of station icons, each station icon corresponding to a different one of a plurality of stations defined by the media application, each station icon being selectable by a user to play one or more media tracks from a playlist associated with the corresponding station,
wherein at least two of the plurality of station icons are dynamic icons, each dynamic icon including an artwork image associated with a current media track for the corresponding station and a progress indicator that advances in emulation of real-time playback of the current media track,
wherein when the progress indicator reaches the end of the current media track, the image for the dynamic icon changes to an artwork image associated with a next media track in the playlist associated with the corresponding station and the progress indicator is reset based on a duration of the next media track.

2. The graphical user interface of claim 1 wherein the station icons are arranged as an array that is scrollable by a user and wherein only a portion of the array is displayed within the stations region at a given time.

3. The graphical user interface of claim 1 further comprising a current station marker that is displayed over the one of the plurality of station icons that corresponds to a current station for which a media track from the associated playlist is currently being played.

4. The graphical user interface of claim 3 wherein the station icons are arranged as an array that is scrollable by a user and wherein only a portion of the array is displayed within the stations region at a given time and wherein the current station marker moves together with the station icon that corresponds to the current station when the array is scrolled.

5. The graphical user interface of claim 1 wherein in the event that the user selects one of the dynamic icons, the playlist associated with the station corresponding to the selected dynamic icon begins to play and wherein playing of the playlist begins with the media track for which the corresponding artwork image is currently included in the dynamic icon.

6. The graphical user interface of claim 5 wherein playing of the playlist begins with the media track for which the corresponding artwork image is currently included in the dynamic icon and at a point within the media track corresponding to the progress indicator.

7. The graphical user interface of claim 1 wherein at least one of the plurality of station icons is a static icon that includes an unchanging image.

8. A method of providing a user interface for interacting with media tracks, the method comprising:
defining a plurality of stations, each station having an associated playlist of media tracks, the plurality of stations including at least a first station associated with a first playlist and a second station associated with a second playlist;
displaying, in a stations region of a display, a first station icon selectable by a user to select the first station, the first station icon including a first artwork image associated with a current media track of the first playlist and a first progress indicator that advances in emulation of real-time presentation of the current media track of the first playlist;
while displaying the first station icon, displaying, in the stations region of the display, a second station icon selectable by a user to select the second station, wherein the second station icon includes a second image associated with a current media track of the second playlist and a second progress indicator that advances in emulation of real-time presentation of the current media track of the second playlist;
when the first progress indicator reaches a state corresponding to an end of the current media track of the first playlist, replacing the first image with a third image corresponding to a next media track of the first playlist and resetting the first progress indicator; and
when the second progress indicator reaches a state corresponding to an end of the current media track of the second playlist, replacing the second image with a fourth image corresponding to a next media track of the second playlist and resetting the second progress indicator.

9. The method of claim 8 further comprising:
receiving a user input selecting the first station as a current station while the third image is displayed; and
in response to the user input, playing the media track of the first playlist that corresponds to the first playlist.

10. The method of claim 9 further comprising:
in response to the user input, displaying a current station marker overlaying the first station icon.

11. The method of claim 8 wherein the first station icon and the second station icon are elements of an array of station icons corresponding to different ones of the plurality of stations, wherein only a portion of the array of station icons is visible in the stations region of the display, and wherein the method further comprises:
receiving a user input indicating that the array of station icons should be scrolled; and
scrolling the array of station icons in response to the user input, wherein the first progress indicator and the second progress indicator continue to advance as the array of station icons is scrolled.

12. A graphical user interface for a media application, the graphical user interface comprising:
a now-playing region that displays identifying information for a currently playing media track; and
a history region adjacent to the now-playing region, the history region including a plurality of display positions, each display position presenting identifying information for one of a plurality of previously played media tracks, the display positions being ordered according to recency of playing of the previously played tracks;
wherein upon completion of playing of the currently playing media track, the identifying information for the newly completed media track is moved, using an animated transition, into a first display position of the history region while the identifying information for each of the previously played media tracks shifts to a next display position of the history region.

13. The graphical user interface of claim 12 wherein the animated transition includes reducing a size of the identifying information for the newly completed media track.

14. The graphical user interface of claim 12 wherein at least one of the display positions in the history region includes a control operable by a user to purchase the media track whose identifying information is displayed in that one of the display positions.

15. The graphical user interface of claim 12 wherein the history region is arranged such that the display positions are scrollable by a user to view less recently played media tracks.

16. The graphical user interface of claim 12 wherein the now-playing region further includes a plurality of controls operable by the user to interact with the currently playing media track.

17. The graphical user interface of claim 16 wherein the plurality of controls includes one or more of:
a feedback control operable to indicate the user's opinion of the currently playing media track;
a purchasing control operable to purchase the currently playing media track from a media store; or
a station creation control operable to create a new media station for the media application using the currently playing media track as a seed.

18. A method of providing a user interface for interacting with media tracks, the method comprising:
playing a currently playing media track;
displaying, in a now-playing region of the user interface, identifying information for the currently playing media track;
displaying, in a history region adjacent to the now-playing region, a plurality of display positions, each display position presenting identifying information for one of a plurality of previously played media tracks, the display positions being ordered according to recency of playing of the previously played tracks; and
upon completion of playing of the currently playing media track, moving the identifying information for the newly completed media track, using an animated transition, into a first display position of the history region while shifting the identifying information for each of the previously played media tracks to a next display position of the history region.

19. The method of claim 18 wherein, during the animated transition, the size of the displayed identifying information for the newly completed media track is reduced to a size associated with displaying identifying information in the history region.

20. The method of claim 18 further comprising:
receiving user input indicative of scrolling the history region; and
in response to the user input, scrolling the history region to display identifying information for one or more less recently played media tracks.

21. A method for presenting audio content to a user, the method comprising, by an electronic device:
playing audio content;
while playing the audio content, displaying a graphical user interface that includes a control element operable to control playing of the audio content and a rendered image of a speaker;
detecting whether an object is in contact with at least a portion of the rendered image of the speaker; and
in the event that an object is detected in contact with at least a portion of the rendered image of the speaker, modifying a property of the playing audio content based on the detected contact.

22. The method of claim 21 wherein modifying a property of the playing audio content includes reducing a volume of the playing audio content.

23. The method of claim 21 wherein modifying a property of the playing audio content includes reducing a high frequency component of the playing audio content.
